(19) United States
(12) Patent Application Publication
(10) Pub. No.: US 2010/0225106 A1
(43) Pub. Date: Sep. 9, 2010

(54) MULTIFUNCTION FLUID CONNECTOR FOR AUTOMOTIVE VEHICLE POWER SYSTEM

(75) Inventors: Christopher William Newman, Farmington Hills, MI (US); Jeff Richard Kosko, Dearborn, MI (US); Terrance Wagner, Milan, MI (US)

Correspondence Address: Jerome R. Drouillard, 10213 Tims Lake Blvd., Grass Lake, MI, 49240, US

(73) Assignee: FORD GLOBAL TECHNOLOGIES LLC, Dearborn, MI (US)

(21) Appl. No.: 12/399,110

(22) Filed: Mar. 6, 2009

(51) Int. Cl. F16L 41/00

(52) U.S. Cl. 285/204; 285/201; 285/205

(57) ABSTRACT

A multifunction fluid connector for an automotive vehicle power system includes a base component having at least one passage for conducting a fluid, with the passage ending in a bore which is closed by a multifunction fluid connector having three functional states in which the connector is either closed, or open to allow attachment of a hose or other conductor in fluid communication with the passage through the base component. In a final state, a fluid handling device such as a PCV valve, a MAP sensor, an EGR valve or other type of fluid handling component may be situated within the bore of the base component.

### CROSS REFERENCE TO RELATED APPLICATIONS

None.

### BACKGROUND OF THE INVENTION

1. Field of the Invention

The present invention relates to a fluid connector having a number of different operating modes rendering the connector particularly useful for automotive vehicle powertrain elements.

2. Related Art

Automotive designers strive to maintain the highest practicable degree of commonality between components used for various vehicular powertrains. For example, an engine intake manifold is expensive to tool and produce, and, as a result, it is desirable to provide a manifold having a design which is suitable for use in several different vehicles. However, tuning of engines and powertrains for different vehicles sometimes requires modifications to the equipment of the engine. For example, oftentimes it is necessary to utilize an exhaust gas recirculation (EGR) valve and sometimes it is not. And, it is desirable to avoid using costly componentry where it is not necessary. At other times, some engines need heated positive crankcase ventilation (PCV) valves, whereas others do not. As a result, added expense is frequently incurred for providing fittings, for example for an EGR valve or heated PCV, where these components are not needed on a particular engine, but may be needed on others.

It would be desirable to provide a multifunction fluid connector which preserves, at minimal cost, the capability of either closing a passage, or providing optional, alternative means for mounting various hardware to a component having a fluid passage.

### SUMMARY OF THE INVENTION

According to an aspect of the present invention, a multifunction fluid connector for an automotive vehicle power system includes a base component having at least one passage for conducting a fluid. A bore formed in the base component will accept a fluid handling device if the bore is accessible. The bore is in fluid communication with the previously described fluid passage. An adapter, which configured integrally with the base component, controls accessibility to the bore by closing an outer portion of the bore. The adapter has a generally tubular first portion with an integral, fluid tight, end, with the fluid tight end being removable to permit installation of a fluid conductor, such as a hose, to the first portion, and with the adapter having a second portion which is removable to permit installation of a fluid handling device within the bore formed in the base component.

According to another aspect of the present invention, a base component may be configured as an intake manifold or other powertrain element, such as a transmission.

According to another aspect of the present invention, the second portion of the adapter includes a foundation structure having a flanged end welded to a wall defining the bore. According to a preferred embodiment, the fluid tight end of the adapter is welded to the first portion of the adapter.

According to another aspect of the present invention, the fluid tight end of the adapter may be preferably arranged as one piece with a remaining part of the first portion of the adapter. The adapter may be one piece with the base component itself.

According to another aspect of the present invention, an adapter configured as one piece with an engine component and determining access to a bore which is generally cylindrical and which is configured to accept a fluid handling device, and with the bore being in communication with the fluid handling passage for conducting a fluid within an engine component, has three function states, with the states including a first functional state in which the adapter closes the bore, thereby preventing any passage of the fluid through the bore, and a second functional state in which the adapter provides a connection for an added tubular fluid conductor, thereby providing for the passage of fluid through the bore and the fluid conductor. A third functional state is characterized by the entirety of the bore being fully accessible, thereby permitting installation of a fluid handling device within the bore, such as a PCV valve, an EGR valve, or a manifold absolute pressure sensor or other device.

According to another aspect of the present invention, the inventive adapter is reconfigurable from the first functional state to the second functional state by removing a first portion of the adapter, with the adapter being reconfigurable from the second functional state to the third functional state by removing a second portion of the adapter.

It is an advantage of a multifunction fluid conductor according to the present invention that the number of different, unique, components required for service or to be fitted as original equipment on a line of vehicles may be reduced because certain devices such as a PCV fitting, an EGR valve, or manifold pressure sensor or other devices may be added without the necessity of additional hardware, and without providing additional fittings to an engine part such as an intake manifold or transmission case.

It is another advantage of a multifunction fluid connector according to the present invention that the connector is easily modified to move from its first functional state in which the connector is closed, to a second functional state in which the connector is open and available for connection of a conductor such as a hose, and with the connector having a third functional state in which a larger bore is opened to allow fitment of a device such as an EGR valve. It is an added advantage that these operations may be completed without the use of machine tools or expensive machining.

Other advantages, as well as features of the present invention, will become apparent to the reader of this specification.

### BRIEF DESCRIPTION OF THE DRAWINGS

FIG. 1 is a partially schematic view of an engine having a multifunction fluid connector according to the present invention.

FIG. 2 is a sectional view of an automotive component having a multifunction fluid connector according to the present invention.

FIG. 3 is similar to FIG. 2 but shows an end of the multifunction fluid connector having been removed and a hose attached to the connector.

FIG. 4 is illustrates a third functional state of the present multifunction fluid connector in which the connector has been removed to an extent allowing access to a bore which permits mounting of a device such as the illustrated PCV valve.

FIG. 5 is similar to FIG. 2 but shows a one-piece multifunction fluid connector according to an aspect of the present invention.

FIG. 6 is similar to FIG. 5 but shows an EGR valve added to the multifunction fluid connector.

FIG. 7 illustrates a transmission having a multifunction fluid connector according to the present invention.

### DETAILED DESCRIPTION OF THE PREFERRED EMBODIMENTS

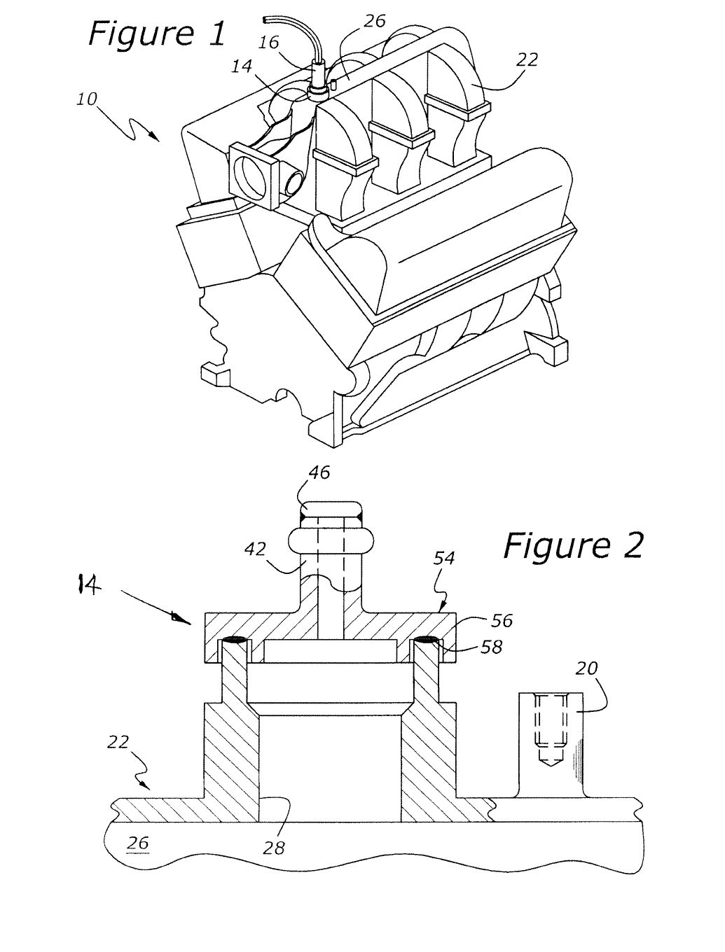

According to an aspect of the present invention shown in FIG. 1, engine 10 has an intake manifold, 22, with a multifunction fluid connector, 14, incorporated therein. A manifold absolute pressure sensor, 16, is mounted to multifunction fluid connector 14. Sensor 16 generates a signal related to the pressure of induction air flowing within manifold 22. This signal is communicated to an engine controller (not shown).

FIG. 2 is a sectional view showing multifunction fluid connector 14 as being mounted to an intake plenum, 26, of intake manifold 22. Intake plenum 26 has a bore, 28, which is closed by multifunction fluid connector 14. More specifically, multifunction fluid connector 14 has a generally tubular first portion, 42, having a closed end, 46. Tube 42 is attached to a second portion, 54, which is a foundation structure having a flanged end, 56, which is attached to the wall of bore 22 by means of a weld bead, 58. The welding may be accomplished by friction welding, solvent welding, fusion welding, ultrasonic welding, or other types of welding processes known to those skilled in the art and suggested by this disclosure.

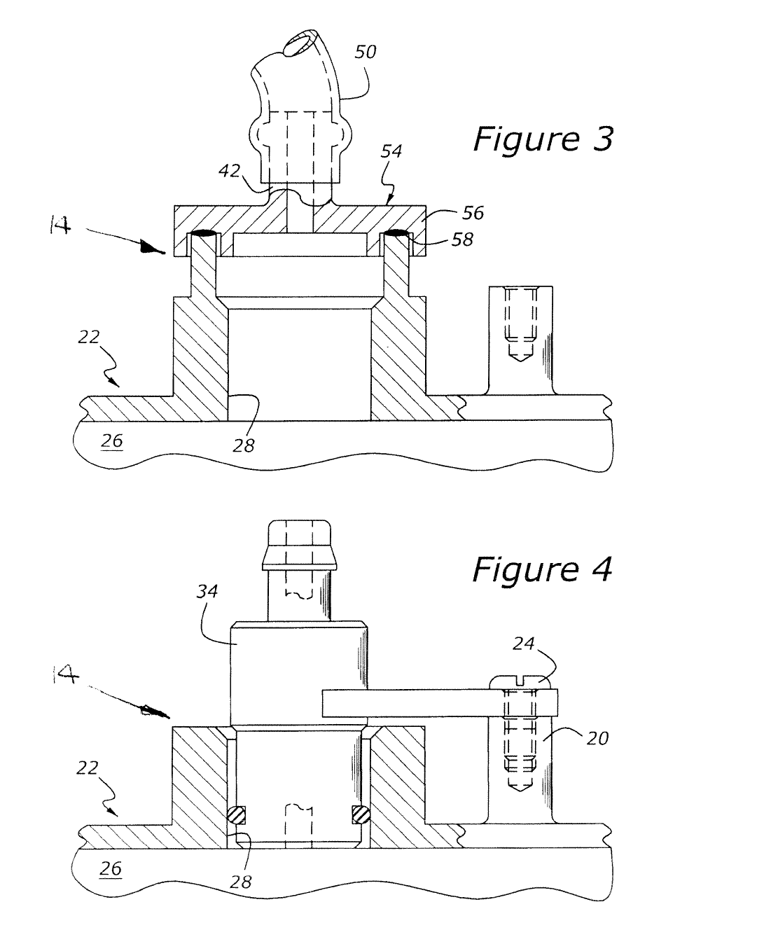

FIG. 3 shows end 46 having been removed from generally tubular first portion 42, to allow for installation of a hose, 50. Although this installation is depicted in conjunction with an intake air plenum, those skilled in the art will appreciate in view of this disclosure that the present invention is useful for connecting such devices as fluid coolers and passenger compartment heater hoses to water passages within a manifold or other engine component, as well as for making connections with remote sensors for manifold air pressure, and other such devices.

FIG. 4 illustrates a third functional state in which flange 56 has been removed, along with tubular first portion 42 and second portion 54. PCV valve 34 has been inserted into bore 28. PCV valve 34 is retained by screw 24 inserted into boss 20. This mounting system is also shown in FIG. 6, in conjunction with an EGR valve.

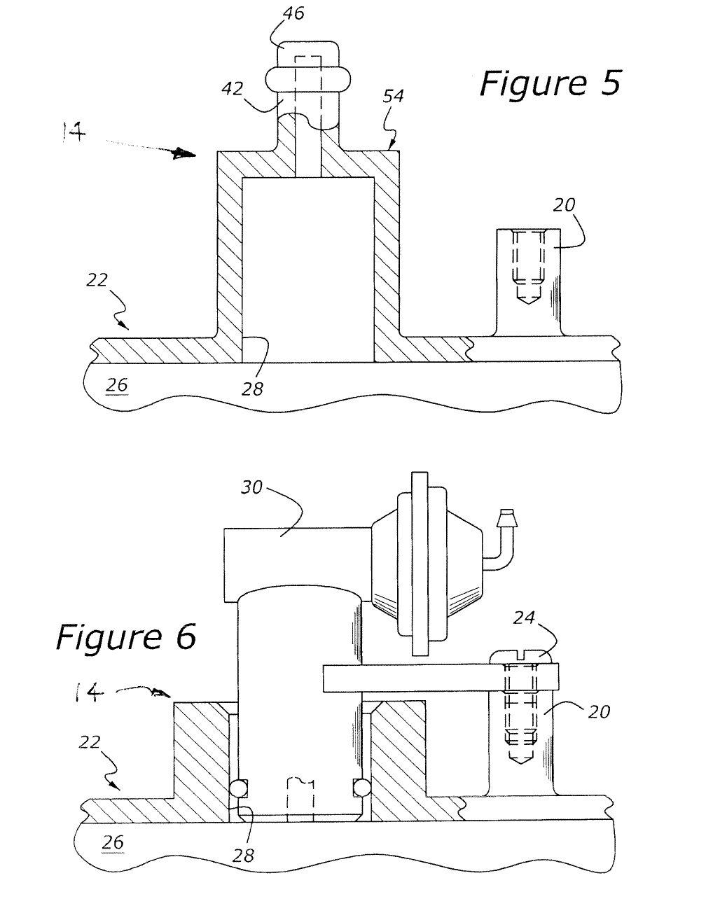

FIG. 5 illustrates an embodiment of the present multifunction fluid connector 14 in which tube end 46, tube 42 and foundation portion 54 are one piece with the structure defining bore 28. In this manner, tube end 46, tube 42, and foundation 54, as well as the wall of bore 28 may be formed with a single casting operation, providing utmost in economy of manufacturing, while nevertheless permitting multifunction use by the severing of end 46, or second portion 54, as required.

FIG. 6 shows another adaptation of the present multifunction fluid connector 14 in its third functional state in which an EGR valve, 30 is mounted to bore 28. Screw 24 is driven into boss 20 to maintain EGR valve 30 within bore 28.

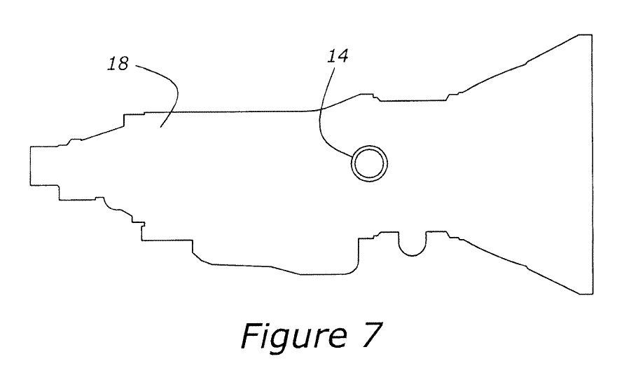

FIG. 7 illustrates a transmission, 18, having a multifunction fluid connector 14 according to the present invention, which may be used for mounting an added oil cooler or other device to the transmission.

It is thus seen that multifunction fluid connector 14 may be either one piece with the base component into which it is installed, or it may be integral and configured with multiple pieces with a separate cap, 46, and a separate flanged end 56 welded or bonded to the wall of bore 28. Regardless of whether it is one piece or multiple pieces, the first, second and third functional states ascribed to the present inventive structure are available to provide maximum functional capability of the inventive multifunction fluid connector. In the first functional state, shown in FIGS. 1 and 5, fluid connector 14 is closed, and no hose or other device is attached to the connector. In the second functional state, shown in FIG. 3, cap 46 has been removed by cutting to allow hose 50 be attached, thereby permitting fluid flow through bore 28 and any passages connected thereto. Finally, in the third functional state, shown in FIGS. 4 and 6, bore 28 has been fully exposed to permit installation of fluid handling devices such as an EGR valve and manifold pressure sensor.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A multifunction fluid connector for an automotive vehicle power system, comprising:
a base component having at least one passage for conducting a fluid;
a bore formed in said base component in fluid communication with said at least one passage, with said bore being adapted for accepting a fluid handling device; and
an adapter configured integrally with said base component and closing an outer portion of said bore, with said adapter having a generally tubular first portion with an integral, fluid tight, end, with said end being removable to permit installation of a fluid conductor to said first portion, and with said adapter having a second portion which is removable to permit installation of a fluid handling device within said bore.

2. A multifunction fluid connector according to claim 1, wherein said base component comprises an intake manifold associated with an engine.

3. A multifunction fluid connector according to claim 1, wherein said base component comprises a powertrain element.

4. A multifunction fluid connector according to claim 3, wherein said powertrain element comprises a transmission.

5. A multifunction fluid connector according to claim 1, wherein said second portion of said adapter comprises a foundation structure having a flanged end joined to a wall defining said bore.

6. A multifunction fluid connector according to claim 1, wherein said fluid tight end of said adapter is welded to said first portion of said adapter.

7. A multifunction fluid connector according to claim 1, wherein said fluid tight end of said adapter is one piece with a remaining part of said first portion of said adapter.

8. A multifunction fluid connector according to claim 1, wherein said fluid handling device comprises an EGR valve.

9. A multifunction fluid connector according to claim 1, wherein said fluid handling device comprises a PCV valve.

10. A multifunction fluid connector according to claim 1, wherein said adapter is one piece with said base component.

11. A multifunction fluid connector for an automotive engine, comprising:
a generally cylindrical bore for accepting a fluid handling device, with said bore being formed in a base component having at least one passage for conducting an engine fluid through said bore; and
an adapter configured integrally with said base component and closing said bore, with said adapter comprising:
a first portion comprising a generally cylindrical, tubular structure having an integral, fluid tight end which is removable to permit installation of a fluid conductor upon said tubular structure to establish fluid communication with said bore and said at least one passage; and
a second portion which is one piece with said first portion, with said second portion comprising a foundation structure which is integral with a wall surrounding said bore, and with said second portion being removable along with said first portion to permit installation of a fluid handling device within said generally cylindrical bore.

12. A multifunction fluid connector according to claim 11, wherein said bore is formed in fluid communication with an intake manifold vacuum passage.

13. A multifunction fluid connector according to claim 12, wherein said second portion is welded to said wall of said bore.

14. A multifunction fluid connector according to claim 12, wherein said bore is configured to accept a PCV valve.

15. A multifunction fluid connector according to claim 11, wherein said fluid tight end is one piece with said tubular structure.

16. A multifunction fluid connector according to claim 11, wherein said first portion of said adapter and said second portion of said adapter are one piece with the base component.

17. A multifunction fluid connector for an automotive engine, comprising:
a generally cylindrical bore for accepting a fluid handling device, with said bore being in communication with at least one passage for conducting an engine fluid within an engine component; and
an adapter configured as one piece with said engine component and determining access to said bore, with said adapter having three functional states, with said states comprising:
a first functional state in which the adapter closes said bore, thereby preventing any flow of fluid through said bore;
a second functional state in which the adapter provides a connection for an added tubular fluid conductor, thereby providing for the flow of fluid through said bore and said fluid conductor; and
a third functional state in which the entirety of said bore is fully accessible, thereby permitting installation of a fluid handling device within said bore.

18. A multifunction fluid connector according to claim 17, wherein said adapter is reconfigurable from said first functional state to said second functional state by removing a first portion of said adapter, and with said adapter being reconfigurable from said second functional state to said third functional state by removing a second portion of said adapter.

19. A multifunction fluid connector according to claim 17, wherein said engine component comprises an intake manifold, and said fluid handling device comprises an EGR valve.

20. A multifunction fluid connector according to claim 17, wherein said engine component comprises an intake manifold, and said fluid handling device comprises a MAP sensor.
